(19) United States
(12) Patent Application Publication
(10) Pub. No.: US 2009/0039171 A1
(43) Pub. Date: Feb. 12, 2009

(54) THERMOSTAT DEVICE OF A WATER HEATER

(76) Inventor: Li-Sui Huang, Chia-I City (TW)

Correspondence Address: WPAT, PC;INTELLECTUAL PROPERTY ATTORNEYS, 2030 MAIN STREET, SUITE 1300, IRVINE, CA, 92614, US

(21) Appl. No.: 11/835,227

(22) Filed: Aug. 7, 2007

(51) Int. Cl. G05D 23/13; G05D 23/02

(52) U.S. Cl. 236/93 R; 236/12.2

(57) ABSTRACT

A thermostat device f a water heater includes a container having a thermostat chamber and a heating chamber interconnecting each other. The thermostat chamber comprises a water inlet pipe and a water outlet pipe. A temperature adjusting valve is provided in the water inlet pipe. The water inlet pipe has a first outlet interconnecting with the thermostat chamber and a second outlet interconnecting with the heating chamber. A heating device is provided in the heating chamber. An outlet is provided to interconnect the thermostat chamber and the heating chamber. A one-way valve is provided on the outlet. The one-way valve is controlled by the temperature adjusting valve to turn on or off the first outlet in order to maintain a constant temperature of the water.

### BACKGROUND OF THE INVENTION

1. Field of the Invention

The present invention relates to a thermostat device of a water heater, and more particularly to a device that enables to heat cold water, to mix cold and hot water and to output a water with predetermined temperature.

2. Description of the Prior Art

A conventional heater requires cold water to flow through a faucet first before hot water can be provided. In many cases, the user will let the cold water to drain out from the waste pipe, which is a waste of nature resource and of time.

### SUMMARY OF THE INVENTION

According to the present invention, there is provided a thermostat device of a water heater comprising a container having a thermostat chamber and a heating chamber interconnecting each other, a water inlet pipe and a water outlet pipe being provided in said thermostat chamber, said water inlet pipe having a first outlet and a second outlet, said first outlet interconnecting with said thermostat chamber, said thermostat chamber and said heating chamber being interconnected with an outlet, a one-way valve being provided on said outlet enabling water in said heating chamber to enter into said thermostat chamber; a heating device disposed in said heating chamber; and a temperature adjusting valve disposed in said thermostat chamber, said temperature adjusting valve comprising a valve block, a linking rod, and a retractable member, said linking rod being inserted into said retractable member, one end of said linking rod being connected to said valve block, said valve block being linked with said retractable member to move when temperature changed.

Preferably, a heating room is provided in said heating chamber between said second outlet and said outlet.

Preferably, said heating device is a pipe covered with a semiconductor electrothermal film, and a pair of electrical conducting plates is provided at two ends of said electrothermal film.

Preferably, a spring is provided on said linking rod and extends within a fixture, said fixture being secured to the outside of said first outlet of said water inlet pipe.

Preferably, said retractable member of said temperature adjusting valve is a retractable box filled with volatile liquid.

Preferably, said retractable member of said temperature adjusting valve is a box provided with a spring thereon.

Preferably, said box is filled with a wax ball.

Preferably, said one-way valve comprises a block plate and an elastic element, said block plate being urged by said elastic element to block said outlet, through holes being provided on an outer circumferential portion of said one-way valve.

Preferably, said one-way valve comprises a locator having a locating hole for a supporting rod to insert therethrough, said supporting rod comprising a block plate at one end and a protuberance at the other end thereof, said locator further comprising through holes.

Preferably, said second outlet of said water inlet pipe is provided with a cold water inlet pipe interconnecting with said heating chamber.

Preferably, a first thermometer is provided on said heating chamber.

Preferably, a second thermometer is provided on said water outlet pipe.

This invention enables to adjust the cold water and hot water depending upon the temperature is monitored, providing water with a constant temperature when it is necessary.

### BRIEF DESCRIPTION OF THE DRAWINGS

FIG. 1 is a side cross-sectional view of a preferred embodiment of the present invention;

FIG. 2 is an enlarged view of the preferred embodiment of the present invention showing that a first outlet is blocked by a valve block;

FIG. 3 is a view similar to FIG. 2 with the first outlet in an open status;

FIG. 4 is side cross-sectional view of another embodiment showing that a one-way valve in a closed status; and

FIG. 5 is a view similar to FIG. 4 with the one-way valve in an open status.

### DETAILED DESCRIPTION OF THE PREFERRED EMBODIMENTS

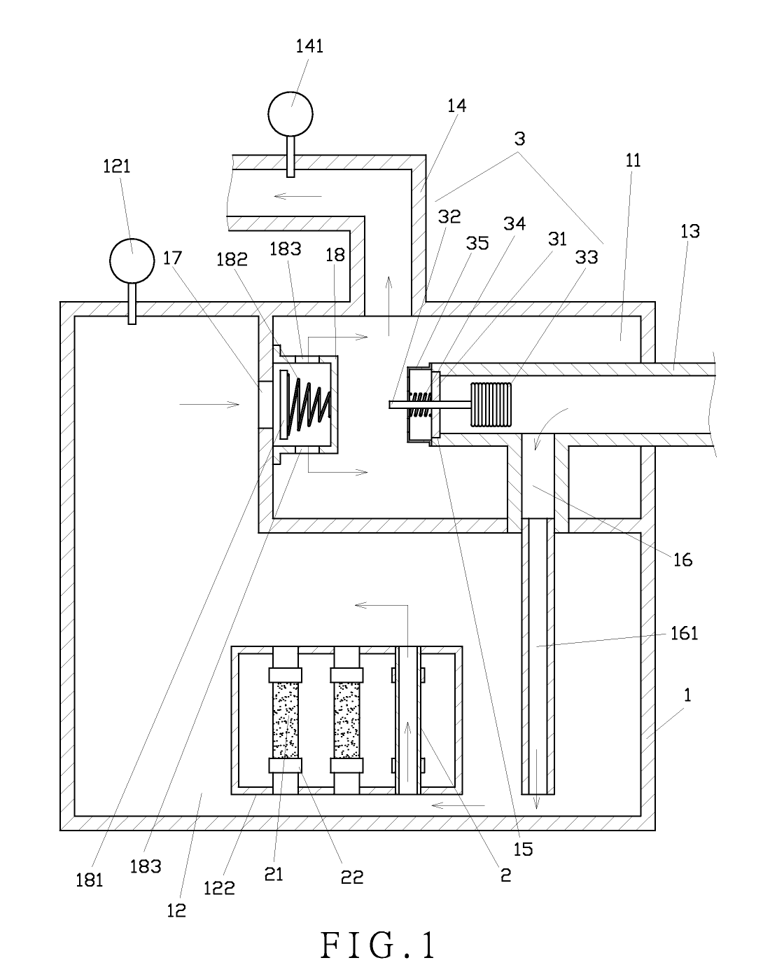

As shown in FIG. 1, a preferred embodiment of the present invention comprises a container 1, a heating device 2, and a temperature adjusting valve 3.

The container 1 comprises a thermostat chamber 11 and a heating chamber 12. A first thermometer 121 is provided on the heating chamber 12. The thermostat chamber 11 comprises a water inlet pipe 13 and a water outlet 14 pipe. A second thermometer 141 is provided on the water outlet pipe 14. The water inlet pipe 13 comprises a first outlet 15 and a second outlet 16. The first outlet 15 interconnects with the thermostat chamber 11. The second outlet 16 is provided with a cold water inlet pipe 161 which interconnects with the heating chamber 12. The cold water inlet pipe 161 is extending near the bottom of the heating chamber 12. An outlet 17 is formed between the thermostat chamber 11 and the heating chamber 12. A one-way valve 18 is provided on the outlet 17. The one-way valve 18 guides hot water from the heating chamber 12 into the thermostat chamber 11, and comprises a block plate 181 and an elastic element 182. Through holes 183 are formed around an outer circumferential portion of the one-way valve 18. The block plate 181 is urged by the elastic element 182 to block the outlet 17. A heating room 122 is provided in the heating chamber 12 between the second outlet 16 and the outlet 17.

The heating device 2 is disposed in the heating room 122 in the heating chamber 12. The heating device 2 is a pipe covered with a semiconductor electrothermal film 21. The electrothermal film 21 is provided with electric conducting plates 22 at two ends thereof. When the electric conducting plates 22 are conducted, the electrothermal film 21 will heat the water in the heating device 2.

The temperature adjusting valve 3 is disposed in the water inlet pipe 13 of the thermostat chamber 11. The temperature adjusting valve 3 comprises a valve block 31, a linking rod 32, a retractable member 33, a spring 34 and a fixture 35. The retractable member 33 is a retractable box filled with volatile liquid, such as ether. The retractable member 33 is located in the first outlet 15. The linking rod 32 is inserted into the retractable member 33 with one end connected to the valve block 31. The valve block 31 is linked by the retractable member 33 to slide depending on the temperature. The valve block 31 blocks the first outlet 15. The spring 34 is inserted onto the linking rod 32 and extends within the fixture 35. The fixture 35 is secured to the outside of the first outlet 15 of the water inlet pipe 13.

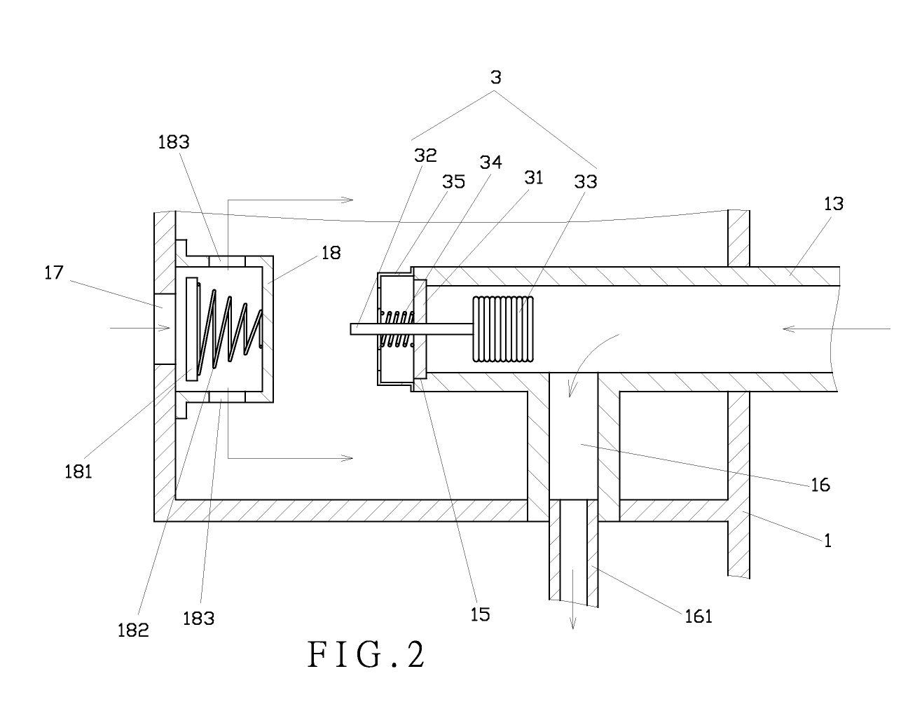

As shown in FIGS. 1 and 2, the water inlet pipe 13 is connected to a cold water supply. The valve block 31 of temperature adjusting valve 3 blocks the first outlet 15 of the water inlet pipe 13. The first outlet 15 of the water inlet pipe 13 and the thermostat chamber 11 are in a closed status. The cold water in the water inlet pipe 13 is drained through the second outlet 16 and the cold water inlet pipe 161 into the heating device 2 in the heating chamber 12 and is heated by the electrothermal film 21. The heated water will arise and the temperature of the hot water in the heating chamber 12 will be detected by the first thermometer 121. The hot water further pushes the block plate 181 of the one-way valve 18, and then urges the elastic element 182 to open the through holes 183 so that the hot water flows into the thermostat chamber 11 and out from the water outlet pipe 14. The second thermometer 141 will detect the temperature of water flowing through the water outlet pipe 14.

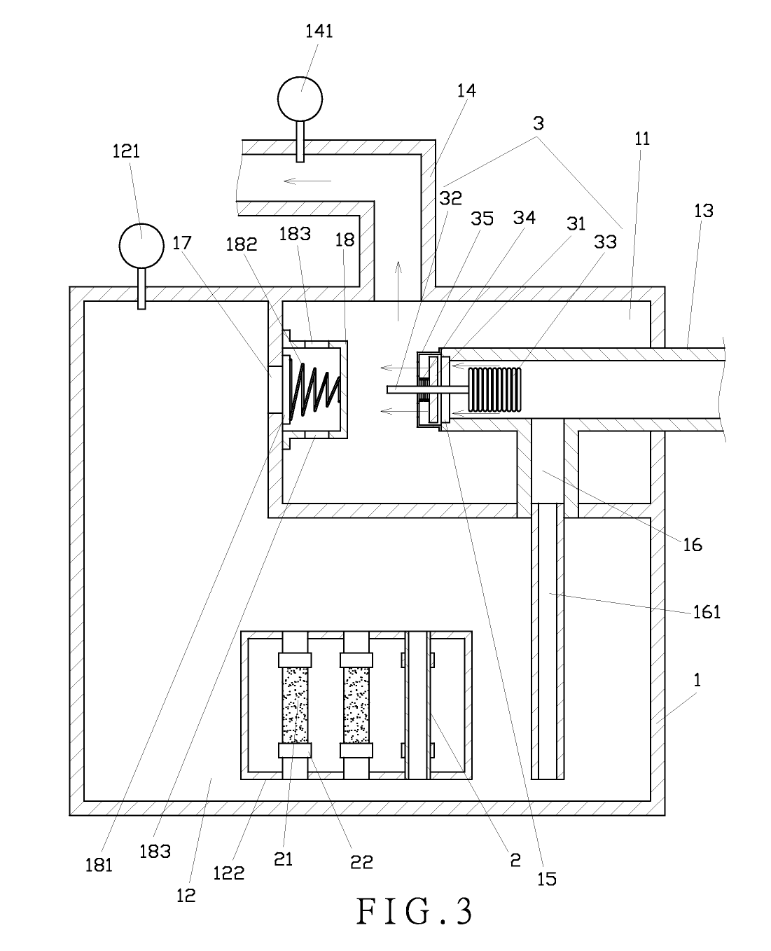

When the hot water exceeds the predetermined temperature set by the temperature adjusting valve 3, as shown in FIG. 3, the volatile liquid stored in the retractable member 33 will be vaporized to expand its size, which forces the extractable member 33 to extend and in turn urges the linking rod 32 and the valve block 31 to extend. The spring 34 is also urged to change the closed status of the first outlet 15 to an open status, allowing cold water to flow through the first outlet 15 into the thermostat chamber 11. The cold water in the water inlet pipe 13 continues to flow into the heating chamber 12 through the second outlet 16. The cold water flowing through the first outlet 15 into the thermostat chamber 11 mixes with the hot water to change the temperature. When the temperature of the mixed water in the thermostat chamber 11 reaches to the predetermined temperature, the block plate 181 urged by the elastic member 182 will block the outlet 17. The mixed water flows through the water outlet pipe 14. When the temperature of the water in the thermostat chamber 11 is lower than the predetermined temperature, the retractable member 33 will retract to link the linking rod 32 and the valve block 31 to retract simultaneously. The spring 34 urges the valve block 31 to block the first outlet 15 of the water inlet pipe 13 again, so that the cold water is blocked from entering into the thermostat chamber 11, as shown in FIG. 1.

The retractable member 33 of the temperature adjusting valve 3 in the above-mentioned embodiment is in a retractable box type. The retractable member 33 of the temperature adjusting valve 3 may be a box provided with a spring on the box. The box is filled with a wax ball. When the wax ball is heated, it will melt into liquid and produce a pressure against the box, which links the linking rod 23 to move simultaneously.

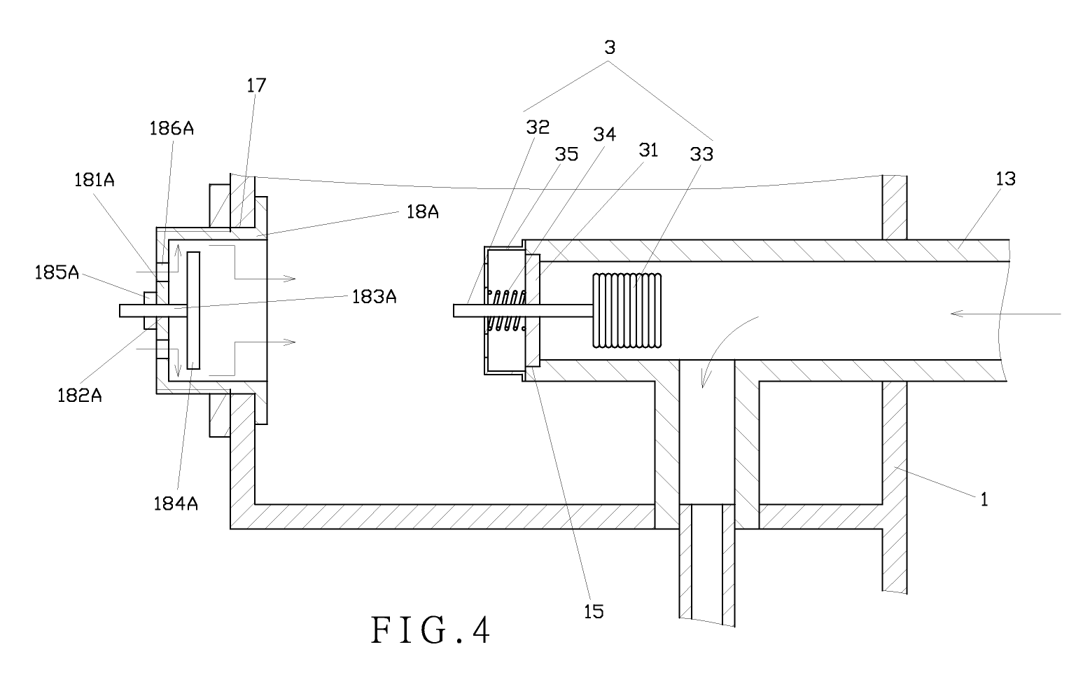

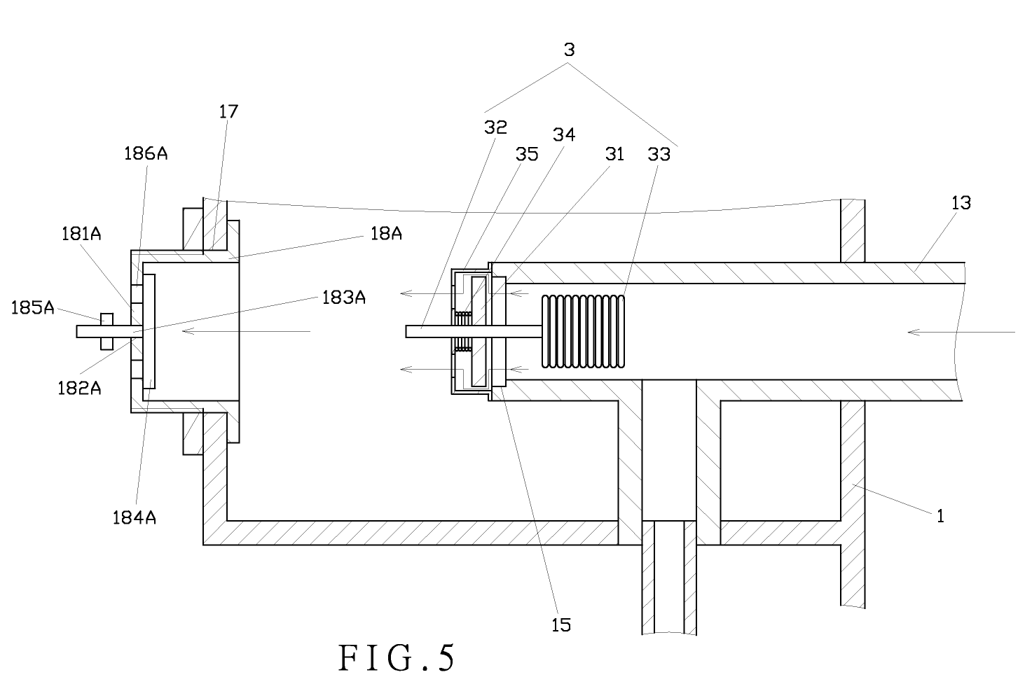

FIGS. 1 and 4 show another embodiment of the present invention. A one-way valve 18A comprises a locator 181A and a supporting rod 183A. The locator 181A has a locating hole 182A and through holes 186A. The supporting rod 183A is inserted through the locating hole 182A. One end of the supporting rod 183A is provided with a block plate 184A and the other end is provided with a protuberance 185A to restrain the supporting rod 183A detaching from the locating hole 182A. The one-way valve 18A is disposed on the outlet 17. The hot water in the heating chamber 12 will arise and flow through the through holes 186A of the locator 181A and then push the block plate 184A so that the hot water flows through the through holes 186A and the outlet 17 into the thermostat chamber 11 and then flows through the water outlet pipe 14. If the hot water exceeds the predetermined temperature set by the temperature adjusting valve 3, as shown in FIGS. 3 and 5, the cold water will flow through the water inlet pipe 13 into the thermostat chamber 11 and mix with the hot water therein to drop the heat to an appropriated temperature. The heat from the hot water will urge the block plate 181A of the one-way valve 18A to close the outlet 17, so that the mixed water only flows through the water outlet pipe 14.

What is claimed is:

1. A thermostat device of a water heater, comprising:
a container comprising a thermostat chamber and a heating chamber interconnecting each other, a water inlet pipe and a water outlet pipe being provided in said thermostat chamber, said water inlet pipe having a first outlet and a second outlet, said first outlet interconnecting with said thermostat chamber, said thermostat chamber and said heating chamber being interconnected with an outlet, a one-way valve being provided on said outlet enabling water in said heating chamber to enter into said thermostat chamber;
a heating device disposed in said heating chamber; and
a temperature adjusting valve disposed in said thermostat chamber, said temperature adjusting valve comprising a valve block, a linking rod, and a retractable member, said linking rod being inserted into said retractable member, one end of said linking rod being connected to said valve block, said valve block being linked with said retractable member to move when temperature changed.

2. The thermostat device of a water heater, as recited in claim 1, wherein a heating room is provided in said heating chamber between said second outlet and said outlet.

3. The thermostat device of a water heater, as recited in claim 1, wherein said heating device is a pipe covered with a semiconductor electrothermal film, and a pair of electrical conducting plates is provided at two ends of said electrothermal film.

4. The thermostat device of a water heater, as recited in claim 1, wherein a spring is provided on said linking rod and extends within a fixture, said fixture being secured to the outside of said first outlet of said water inlet pipe.

5. The thermostat device of a water heater, as recited in claim 1, wherein said retractable member of said temperature adjusting valve is a retractable box filled with volatile liquid.

6. The thermostat device of a water heater, as recited in claim 1, wherein said retractable member of said temperature adjusting valve is a box provided with a spring thereon.

7. The thermostat device of a water heater, as recited in claim 6, wherein said box is filled with a wax ball.

8. The thermostat device of a water heater, as recited in claim 1, wherein said one-way valve comprises a block plate and an elastic element, said block plate being urged by said elastic element to block said outlet, through holes being provided on an outer circumferential portion of said one-way valve.

9. The thermostat device of a water heater, as recited in claim 1, wherein said one-way valve comprises a locator having a locating hole for a supporting rod to insert therethrough, said supporting rod comprising a block plate at one end and a protuberance at the other end thereof, said locator further comprising through holes.

10. The thermostat device of a water heater, as recited in claim 1, wherein said second outlet of said water inlet pipe is provided with a cold water inlet pipe interconnecting with said heating chamber.

11. The thermostat device of a water heater, as recited in claim 1, wherein a first thermometer is provided on said heating chamber.

12. The thermostat device of a water heater, as recited in claim 1, wherein a second thermometer is provided on said water outlet pipe.
